(19) United States
(12) Patent Application Publication
(10) Pub. No.: US 2009/0153390 A1
(43) Pub. Date: Jun. 18, 2009

(54) Arbitration system and method for use with wireless remote control devices in a multiple video screen entertainment system

(76) Inventors: Shawn R. Zackschewski, Kokomo, IN (US); Bradley E. Boyer, Kokomo, IN (US); David E. Wittenbach, Kokomo, IN (US); David L. Bishop, Kokomo, IN (US)

Correspondence Address: DELPHI TECHNOLOGIES, INC., M/C 480-410-202, PO BOX 5052, TROY, MI, 48007, US

(21) Appl. No.: 12/002,730

(22) Filed: Dec. 18, 2007

(51) Int. Cl. H04L 17/02

(52) U.S. Cl. 341/176

(57) ABSTRACT

An arbitration system and method for use with wireless remote control devices in a multiple video screen entertainment system includes transmitting a control signal from the remote to one or more video devices in the entertainment system. The control signal is received at a video screen where the signal strength of the control signal is measured at each device. A signal representing the received signal strength is transmitted from a video device to the remote and a comparison is made of the received signal strength of each of the received signals from each video device at the remote. The remote is then associated to the video device having the highest signal strength where a command is transmitted from the remote with an identification indication for its control of that video device.

### TECHNICAL FIELD

The present invention relates generally to remote control of video equipment and more particularly to a method for controlling one more video units in an entertainment system using a single type of remote control device.

### BACKGROUND OF THE INVENTION

The single video screen type of rear seat entertainment (RSE) systems are well-known in the art and commonly used in many types of vehicular applications. Many of these systems include a wireless remote control (better known simply as a “remote”) that typically uses infrared (IR) frequency transmissions to control operation of the RSE system. Most RSE users prefer controlling the system using a remote as they do not have to physically touch the display or contend with “wired” devices in order to control its system operation. As RSE systems continue to grow in popularity, there will be a greater number of video screen systems used all throughout the vehicle. One example is the use of a video screen located in the rear of a front seat vehicle headrest for use by rear seat passengers.

A common passenger complaint often occurs when using remote control IR devices to operate one or more of the RSE systems. It is often expensive and inefficient to require a dedicated remote control for each RSE system. Moreover, manufacturers would prefer not to include a dedicated remote for each video screen. Although remotes have been provided that include a switch for enabling the user to select which RSE to operate, this too becomes a burden to the user as they often cannot determine which switch position operates a particular RSE system. Consequently, a new method is required to overcome these shortcomings that often create customer confusion and dissatisfaction in using RSE systems.

### SUMMARY OF THE INVENTION

An arbitration method for use with wireless remote control devices in a multiple video screen entertainment system where a control signal is transmitted from a wireless remote control device of a plurality of wireless remote control devices and received at at least one video screen in the entertainment system. The signal strength of the control signal is measured proximate to each video screen in the entertainment system and a signal representing the received signal strength is transmitted from the at least one video screen to the wireless remote control device. The received signal strength is compared to each received signal strength signal at the wireless remote control device and the wireless remote control device is associated to the at least one video screen having the highest signal strength. In one embodiment, a command is then transmitted from the remote control device with an identification to the at least one video screen indicating its control.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a block diagram of a remote control arbitration system in accordance with an embodiment of the invention;

FIG. 2 is a flow chart diagram of the process used in connecting with the remote control arbitration system shown in FIG. 1;

FIG. 3 is block diagram of a remote control arbitration system where the video devices communicate via a data link in accordance with an alternative embodiment of the invention;

FIG. 4 is a flow chart diagram of the process used in connection with the remote control arbitration system shown in FIG. 3;

FIG. 5 is a block diagram of a remote control arbitration system where a multi-split screen is used in accordance with an alternative embodiment of the invention;

FIG. 6 is a flow chart diagram of the process used in connection with the remote control arbitration system shown in FIG. 5; and

FIG. 7 is a block diagram showing components of the remote control device used in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION OF THE PREFERRED EMBODIMENTS

Before describing in detail embodiments that are in accordance with the present invention, it should be observed that the embodiments reside primarily in combinations of method steps and apparatus components related to a remote control arbitration system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a remote control arbitration system described herein. The non-processor circuits may include, but are not limited to, a radio receiver, a radio transmitter, signal drivers, clock circuits, power source circuits, and user input devices. As such, these functions may be interpreted as steps of a method to perform arbitration of remote control units used with RSE systems. Alternatively, some or all functions could be implemented by a state machine that has no stored program instructions, or in one or more application specific integrated circuits (ASICs), in which each function or some combination of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

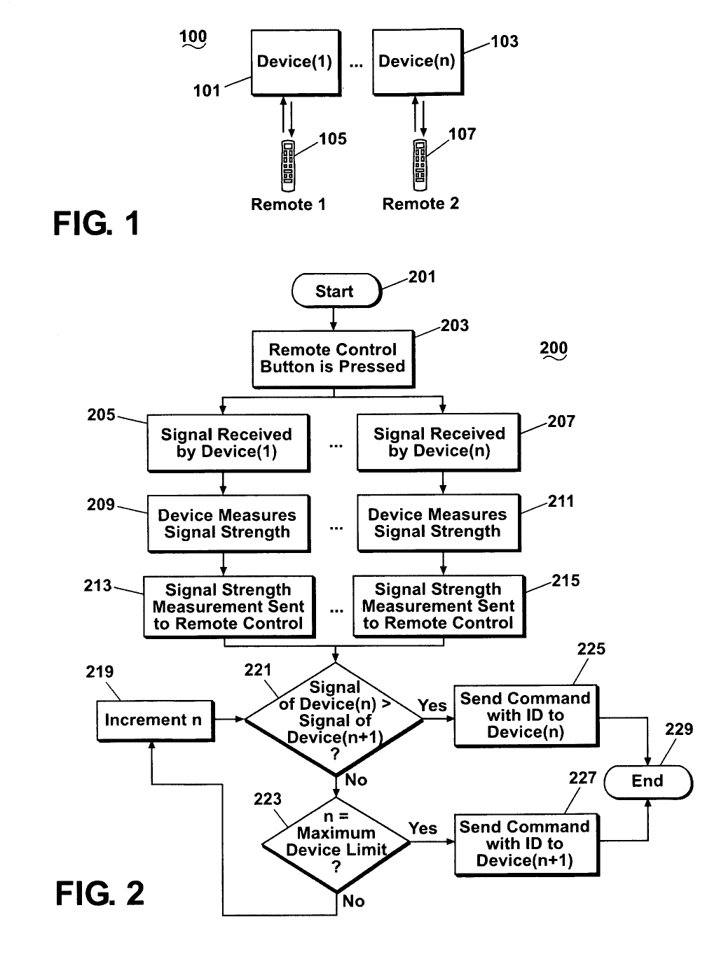

FIG. 1 illustrates a block diagram of the remote control arbitration system for use with an RSE in accordance with an embodiment of the invention. A first video device 101 and one or more second video devices 103 are used in combination with one or more remotes 105, 107. Each of the remote control devices 105, 107 can be used to control either of device 101 or device 103 through the use of infrared (IR) signal strength measurements using the process as described in FIG. 2 herein. In practice, most single video screen RSE systems use a photodiode for receiving IR signals from each remote. However, it will be recognized that radio frequency (RF) or other types of wireless communication may be used as well. In IR applications, the photo-diode output is internally demodulated, converted into the originally transmitted binary string, and processed upon using a microprocessor (not shown). As illustrated in FIG. 1, the remote 105 is shown controlling device 101 and remote 107 controlling device 103; however, the method according to the invention will permit control of either device 101, 103 by either of remotes 105, 107 if using the process as defined herein.

Hence, like a single screen system, each screen in the multiple screen system or RSE system will utilize a photodiode type IR receiver. In addition to a demodulated digital output, an analog signal strength output component can also be used in connection with the photodiode receiver or sensor. This analog output will allow for each video screen to determine the strength of the received IR signal. Therefore, the photodiode sensor that receives the most direct, lowest loss IR transmission will detect the signal having the highest amplitude, i.e., the signal with the strongest signal strength. Once a control circuit, such as a microprocessor or the like, used in connection with the video screen, has performed a binary conversion and determined the signal strength of a remote control command, it will arbitrate this command with the other video screens to determine if action is required. This process can be done using a type of technique including, but not limited to, a wired or wireless data bus, Bluetooth®, or the like. Therefore, the video screens in multiple RSE systems will arbitrate with one another to determine which one received the highest signal strength of an initial control signal set-up command by the remote. Once arbitration is complete, only the screen that received the strongest signal strength will act on subsequent commands. This will allow one remote control to be used to control multiple video screens where the arbitration process assures that only the targeted screen acts on the desired command. The design of the remote control remains common for ease of manufacturing and low cost.

FIG. 2 is a flow chart diagram illustrating the arbitration process 200 used by a single remote as used in the system as shown in FIG. 1. The process starts 201 where the user actuates a switch 203 by generally pressing a button on the face of the remote. A signal encoded with the appropriate recognition information is then sent via an IR communication or the like, to the device(s). At each device, the encoded signal is received 205, 207 and subsequently processed. Each device determines and/or calculates a measured signal strength value 209, 211. This signal strength measurement is then sent back from each device 213, 215. A comparison is then made between the signal received by each device for that remote 221 such that this comparison is incremented by one device 219 that has received a signal from the remote until all comparisons have been made 223. Once an association has been made between remote and device, commands are sent and/or transmitted that include the identification (ID) of the remote to each of the devices 225, 227. This enables that individual device to be controlled by one or more remote(s). Thereafter, the process subsequently ends 229, since each device now is operated by one respective remote.

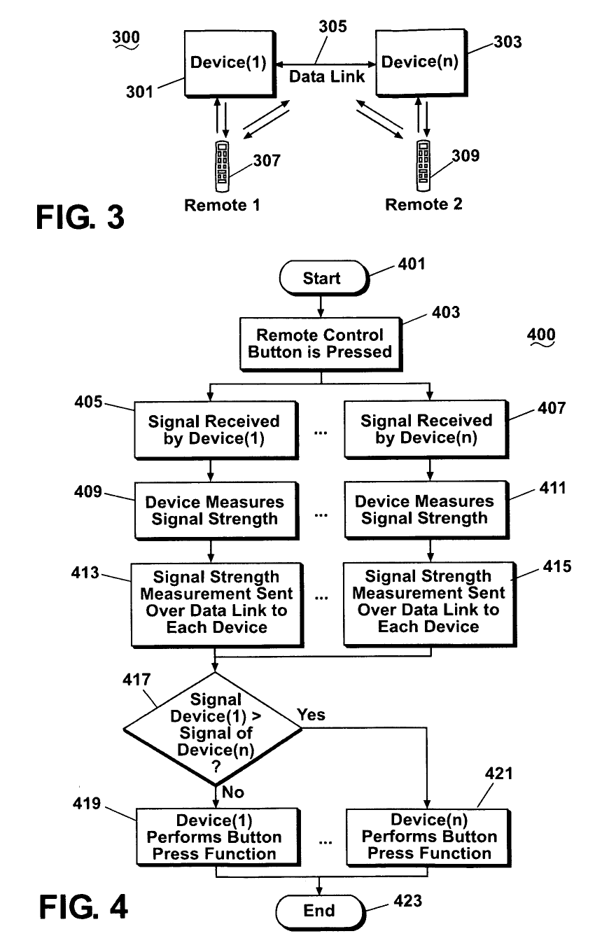

FIG. 3 is a block diagram illustrating an alternative embodiment of the invention where devices 301 and 303 are typically used in an RSE system and communicate via a data link 305. It should be recognized that the data link 305 may be a hard-wired connection or a wireless connection using a WiFi standard communication or the like. A plurality of remotes 307, 309 are used to control the devices 301, 303 as described in the process shown in FIG. 4. This alternative embodiment is direct to a method for determining which source is being selected/changed with a single IR remote control, and relies on the remote and the equipment being controlled to have bi-directional communication capabilities. A first method involves the remote control being capable of making a decision based on the device's reporting signal strength.

In operation, a user would press a control button on the remote control while pointing at the RSE unit. Each IR receiving device (HVAC, RSE, head-unit, etc.) that receives the signal will determine a measurement of relative IR signal strength. Each device, in a specific predetermined time period after receiving the signal from the remote, will respond back with an acknowledgment and signal strength measurement via an IR transmission. The remote control will receive these measurements, select the appropriate code-set based on the measurement, and send out the subsequent control activation command for the RSE. In this example, the remote control and the receiving devices must have an IR receiver and transmitter built in. Careful consideration must be made to make sure that the receiving devices respond back at their specific interval, as not to corrupt one another's IR transmissions. Still another option would include having some type of reverse function or “undo” command for instances where the wrong command was sent.

An additional method includes allowing each receiving device to measure the relative incoming IR signal, have a pre-programmed minimum signal level that it must receive, and react to the command if the signal meets some minimum threshold strength, although there might be difficulties implementing this method as there is no arbitration method between devices and sometimes multiple devices could react to a command as they could all receive the minimum signal level. Another alternative method would be to allow the remote to measure the IR signal strength where each device could either send out a periodic ID message for the remote control to measure or send out an ID only when it detects IR activity from the remote control. The remote would then measure each responding device's reply acknowledgement and make a determination on what code to send out. This method would use, for example, a “track-forward” type switch or button located on the remote while pointed at the head-unit from the rear seat of the vehicle. The RSE, head-unit, HVAC, etc., receiving the incoming IR transmission will output a unique identification to the remote control at specific pre-programmed time interval. The remote control receives the transmissions, measures the signal strength of each, and makes the determination that the head-unit has the stronger IR signal. Finally, the remote control then sends out the correct pre-programmed command for the head-unit to track-forward.

Still yet another alternative method involves an additional button on the remote control for arbitration. This method would operate as described above, except that the remote control will perform an arbitration process by actuating an arbitration function. Once the video device determines the correct source, an LED or some type of indicator will annunciate to the user what source it selected. The user can then press any button on the remote used by the device and it would perform the necessary function. In addition, the remote control will eventually time out or go to sleep after a predetermined time period. Once the remote is awakened from a sleep mode, it will recall the last device that it controlled. A wakeup on the remote might consist of pressing any button or, if equipped with a motion detection sensor, can wakeup on movement. Since a vehicle's movement could simulate this wakeup by vibration, implementing this type of method will require calibration before use.

FIG. 4 is a flow chart diagram of a process as described in connection with the remote control arbitration system shown in FIG. 3. A switch is actuated 403, such as a button on the face of the remote where an IR signal or the like is transmitted from the remote to the remote devices 405, 407. Each device receiving the IR signal measures the signal strength 409, 411 and a signal strength measurement is communicated over a data link to each device 413, 415. A determination is then made if the strength received from a first device is greater than that received from another device (n) 417. It will be evident that the determination includes a comparison of amplitude signal levels in order to determine the device having an IR signal having the greatest magnitude. Thereafter, either device can be directed to recognize a specific remote based on the highest signal strength in order to operate, control, and/or transmit control commands to the proper video screen using its button press functionality 419, 421 in the multiple video screen system. Once control is established, thereafter the process ends 423.

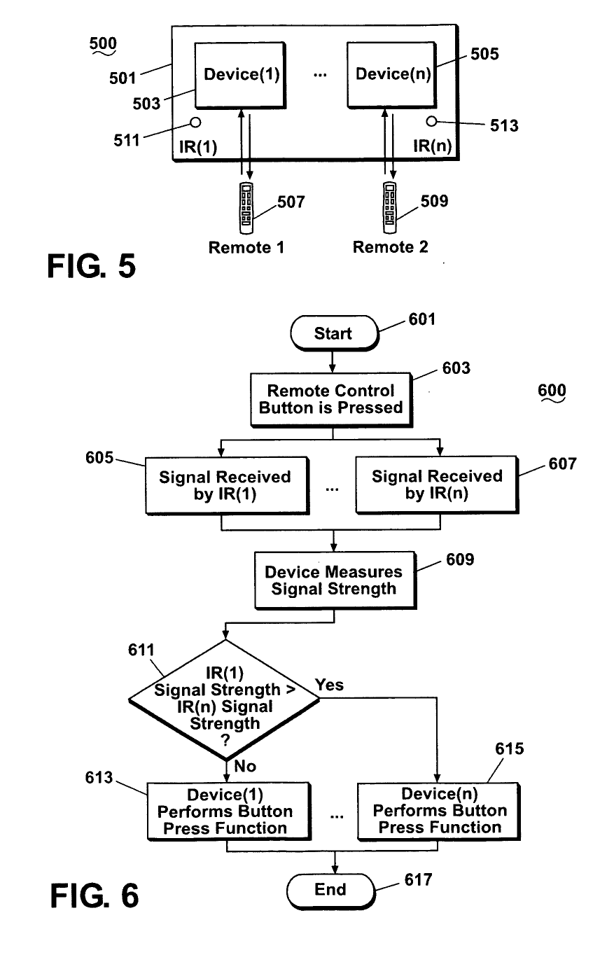

FIG. 5 is a block diagram of a remote control arbitration system 500 where a multi-split screen with multiple remotes is in accordance with an alternative embodiment of the invention. A multi-split screen 501 includes a first split-view 503 and one or more second split-views 505. In operation, a first remote 507 and a second remote(s) can be used to individually control either of the display views 503, 505. Although this example shows only two, it should be evident that any number of various display views with individual remotes could be used.

Accordingly, there is no solution to be able to control a dual-view or triple-view display since only one IR-based remote control is often used to change content on only one of the screens. However, in using the present invention when using an IR-based remote, this type of control can be accomplished in different ways. A first method involves the use of a standard IR remote control having preprogrammed codes for the specific functions. If an array of three IR receivers were placed on the left, center, and right sides of the display, plastic trim molding or other types of IR blocking devices will be used to block the IR signal (as best as possible) from reaching an incorrect IR sensor. When a control button is actuated, the code will be transmitted to the array of receivers. The IR code from one or more sensors would then be used in connection with a microprocessor (not shown). Based on the stronger signal, the microprocessor will change the content of the appropriate screen. Thus, the steps involved in such a process would include actuating a remote control button (i.e., a “play” function) is pressed from the left view screen. The left, center, and right IR sensors detect an incoming IR signal and are electrically attached to the microprocessor that measures the incoming signal and signal strength, and decodes the button press. The strength from IR receiver on the left presumably should be stronger than the receiver center and/or right where the microprocessor sends the play command to the playback responsible for the left-view display.

A second method would include using a “smart” remote control that is capable of bi-directional IR communication. An array of three or more IR receivers are placed on the left, center, and right sides of the multi-view display. A plastic trim molding is then used to block the signal (as best possible) from coming in from an undesired angle. The remote control, when a button is pressed, will send a request to the IR receivers rather than an initial command. The array of three or more receivers will be capable of measuring the signal strength (as in first example above), and then following up with a return command back to the remote to let the remote know what IR code (left, center, or right) it should transmit.

Finally, a third method includes steps for either actuating a button or moving a switch position on the remote control for the left, center, right display views. In practice, this means that the remote control will be required to be programmed with all of the necessary codes in order for it to be multi-functional allowing it to change codes based on the switch position.

FIG. 6 is a flow chart diagram of the process used in connection with an embodiment of the remote control arbitration system as described in FIG. 5. The arbitration process 600 starts 601 with a switch on the remote being actuated, such as a button press on the face of the remote 603. Typically an IR signal, or the like, is sent from the remote and is then received by an IR sensor associated with each display view. A signal is then received by one or more IR sensors that are associated with each individual display view 605, 607. Thereafter, the device with the multi-split screen display measures signal strengths 609 and a determination is made if the signal strength at the first IR sensor IR(1) transmitted from the desired remote is greater than the other sensors IR(n) for each split view. Once determined, the desired display view, e.g., display view (1), then reacts to the button press functionality 613 of a specific remote, as does the display view (n), for each individual remote controlling that display view 615. Once this association has been made by the RSE, this process ends 617.

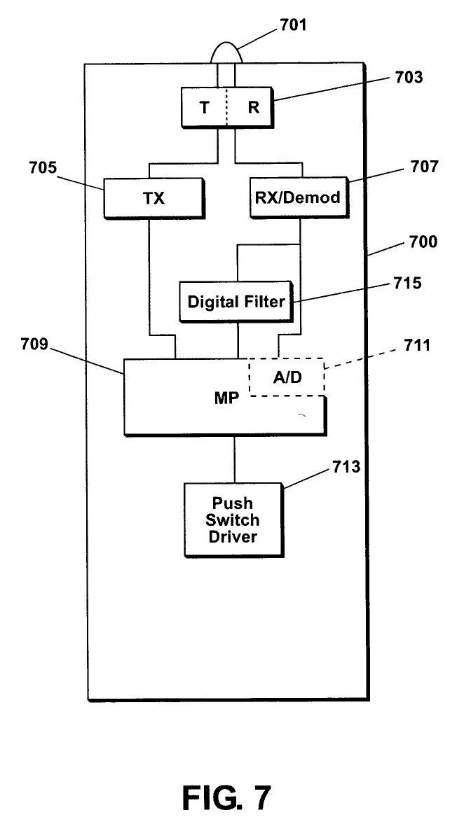

Finally, FIG. 7 is a block diagram showing a typical example of a wireless remote control device 700 in accordance with an embodiment of the invention. The wireless remote control device 700 includes a transmit and a receive diode 701, which are separate IR devices used for transmitting and detecting IR data. A microprocessor (MP) 709 or other type of controller drives the transmit diode 703 through a modulation circuit within a transmitter 705, while a receiver operates by directing the received signal into a demodulator 707 which is split into digital and analog components. The digital portion is amplified and filtered using a digital filter 715 into a series of digital pulses while the analog portion amplified and filtered such that it is supplied to an A/D converter 711 within the microprocessor or other external device. A push switch driver 713 is used to supply user command information to the MP 709.

Thus, the present invention provides a system and method for allowing one remote control device that can be used to control multiple video screens in systems like an RSE system. An arbitration process is provided to ensure that only the targeted video screen acts with the desired remote. The invention is low cost and can be implemented using standard IR commands. Moreover, end user confusion is minimized since there are no switches or menu entries that must be actuated for the user to control a video screen. The user simply points and clicks the remote in order to establish control.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. An arbitration method for use with wireless remote control devices in a multiple video screen entertainment system comprising the steps of:
transmitting a control signal from a wireless remote control device of a plurality of wireless remote control devices;
receiving the control signal at at least one video screen in the entertainment system;
measuring the signal strength of the control signal proximate to each video screen in the entertainment system;
transmitting a signal representing the received signal strength from at least one video screen to the wireless remote control device;
comparing a received signal strength to each received signal strength signal at the wireless remote control device;
associating the wireless remote control device to the at least one video screen having the highest signal strength; and
transmitting a command from the remote control device with an identification to the at least one video screen indicating its control.

2. An arbitration method for use with wireless remote devices as in claim 1, wherein the wireless remote control devices communicate using an infrared (IR) frequency.

3. An arbitration method for use with wireless remote devices as in claim 1, wherein the entertainment system uses a multiple split screen display.

4. An arbitration method for use with wireless remote devices a in claim 1, wherein the entertainment system is used in a vehicle.

5. A method for enabling arbitration of remote control signals in a multiple video screen system comprising the step of:
actuating a control signal from a wireless remote control device of a plurality of wireless remote control devices;
receiving the control signal at at least one video screen in the multiple video screen system;
measuring the strength of the control function signal at the at lest one video screen;
determining one video screen in the multiple video screen system that has the highest signal strength of the control function signal; and
associating the control functionality of the wireless remote control device with that one video screen.

6. A method for enabling arbitration of remote control signals as in claim 5, wherein the step of determining includes the step of:
communicating the signal strength measurements via a data link between at least one video screen and the other video screens in the multiple video screen system; and
comparing the control signal strength of at least one video screen against the signal received at other video screens in the multiple video screen system.

7. A method for enabling arbitration of remote control signals as in claim 5, wherein the wireless remote device operates at an infrared (IR) frequency.

8. A method for enabling arbitration of remote control signals as in claim 5, wherein the multiple video screen system is rear seat entertainment (RSE) system.

9. A method for enabling arbitration of remote control signals as in claim 5, wherein the multiple video screen system utilizes a multiple split screen display.

10. A method for enabling arbitration of remote control signals as in claim 5, wherein the multiple video screen system is used in a vehicle.

11. An arbitration method for use with wireless remote control devices in a rear seat entertainment (RSE) system having a plurality of sensors each associated with a display view in a multi-split display device comprising the steps of:
actuating a control signal from a wireless remote control device of a plurality of wireless remote control devices;
receiving the control signal at at least one sensor associated with a display view in the multi-split screen display device;
measuring the signal strength at at least one sensor;
determining if the signal strength at at least one sensor is greater than the control signal received at each one of the plurality of sensors;
associating the control signal from the wireless remote control device with the display view having the highest signal strength.

12. An arbitration method for use with wireless remote control devices as in claim 11, wherein the wireless remote control device operates in the infrared (IR) frequency range.

13. An arbitration method for use with wireless remote control devices as in claim 11, wherein the RSE utilizes a multiple split screen display.

14. An arbitration method for use with wireless remote control devices as in claim 11, where the RSE is located in a vehicle.

15. An arbitration system for use with at least one wireless remote control device in a multiple video screen entertainment system comprising:
a wireless remote control device of a plurality of wireless remote control devices for transmitting a control signal;
at least one video screen in the entertainment system for receiving the control signal;
a receiver for measuring the signal strength of the control signal proximate to each video screen in the entertainment system;
a transmitter for transmitting a signal representing the received signal strength from at least one video screen to the wireless remote control device;
a processor for associating the wireless remote control device to at least one video screen having the highest signal strength; and
wherein the wireless remote control device operates to compare each received signal strength signal to determine the transmitter having the greatest signal strength.

16. An arbitration system for use with at least one wireless remote device as in claim 15, wherein a command is transmitted from a remote control device with an identification to the at least one video screen having the greatest signal strength indicating its control functionality.

17. An arbitration system for use with at least one wireless remote device as in claim 15, wherein the wireless remote control device communicates using infrared (IR) frequency.

18. An arbitration system for use with at least one wireless remote device as in claim 15, wherein the entertainment system uses a multiple split screen display.

19. An arbitration system for use with at least one wireless remote device as in claim 15, wherein the entertainment system is in a motor vehicle.
